(19) United States
(12) Patent Application Publication
(10) Pub. No.: US 2026/0062307 A1
(43) Pub. Date: Mar. 5, 2026

(54) METHOD OF PREPARING MESOPOROUS CuO MATERIALS

(71) Applicant: KUWAIT UNIVERSITY, SAFAT (KW)

(72) Inventors: MOUSA ZAAL QASEM AL-NOAIMI, SAFAT (KW); ISMAIL KALIL IBNYA WARAD, NABLUS (PS); ABDELKADER ZARROUK, RABAT (MA); ANAS ALALI, NABLUS (PS)

(73) Assignees: LABORATORY OF MATERIALS, NANOTECHNOLOGY AND ENVIRONMENT, MOHAMMED V UNIVERSITY, RABAT (MA); AN-NAJAH NATIONAL UNIVERSITY, NABLUS (PS)

(21) Appl. No.: 19/384,281

(22) Filed: Nov. 10, 2025

Related U.S. Application Data
(63) Continuation-in-part of application No. 18/370,561, filed on Sep. 20, 2023.

(51) Int. Cl. C01G 3/02

(52) U.S. Cl. CPC C01G 3/02; C01P 2004/03; C01P 2004/04; C01P 2004/61; C01P 2004/62; C01P 2006/16

(57) ABSTRACT

A method for preparing mesoporous copper oxide (CuO) includes providing a copper composition including copper (Cu), phenanthroline, and a Schiff base, combining the copper composition with a sodium salt to provide a salt mixture, and calcining the salt mixture to provide the mesoporous CuO. The mesoporous copper oxide has an ordered structure and a diameter ranging from about 0.5 μm to about 3 μm.

### CROSS-REFERENCE TO RELATED APPLICATIONS

This application is a continuation-in-part (CIP) of U.S. patent application Ser. No. 18/370,561, filed on Sep. 20, 2023, the entire contents of which are incorporated herein by reference.

### BACKGROUND

### 1. Field

The disclosure of the present patent application relates to a method for preparing mesoporous CuO materials, and particularly to a method for preparing mesoporous CuO materials by calcining Cu(II)/phen/Schiff base complexes in the presence of a NaX salt.

### 2. Description of the Related Art

Due to their potential uses in a variety of fields like catalysis, sorption, chemical and biological separation, photonic and electronic devices, and drug delivery, mesoporous transition-metal oxides with a well-ordered pore structure and a sizable specific surface area have attracted a lot of interest.

Mesoporous copper oxides have gained particular attention despite being one of several types of mesoporous transition-metal oxides that have been synthesized, including Nb₂O₅, TiO₂, WO₃, MnOₓ, NiO, ZrO₂, Ta₂O₅, V₂O₅, CrOₓ, Co₃O₄ and Fe₂O₃. In industrial uses, for example, the direct conversion of N₂O to N₂ and the complete combustion of hydrocarbons, copper oxides are frequently used as catalyst components.

It is thought that copper oxides with a large specific surface area, and an ordered and crystalline mesoporous structure, achieve better catalytic performance in the aforementioned reactions. Due to their large surface area and some degree of size and shape selectivity, these copper oxides can serve as self-supported catalysts and show high activity. Additionally, because of their consistent porosity, which enables the electrolyte to penetrate deeply into the particles, and because of the possibility of lithium intercalation due to their crystalline walls, they have the potential to be used as electrode materials in lithium-ion batteries.

Considerable effort has been devoted to producing mesoporous metal oxides with large specific surface areas, stability, and consistent pore volumes, as they have potential applications in sensing, catalysis, electronic devices, and photovoltaic solar cells. In recent years, a bottom-up approach to fabricating mesoporous metal oxides using surfactant micelles as a soft template has proven to be an effective method for creating mesoporous silica materials such as SBA-15 and MCM-41. The conventional hydrothermal preparation method used in soft-template preparation for mesoporous structures, however, resulted in a mesostructured assembly that was dependent on the surfactant micelles used during the process.

Thus, a method for preparing mesoporous CuO materials solving the aforementioned problems is desired.

### SUMMARY

A method for preparing mesoporous copper oxide (CuO) includes providing a copper composition including copper (Cu), phenanthroline, and a Schiff base; combining the copper composition with a sodium salt to provide a salt mixture; and calcining the salt mixture to provide the mesoporous CuO. In an embodiment, the phenanthroline has the structure:

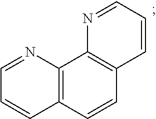 [SMILES: c1cnc2c(c1)ccc1cccnc12]

In an embodiment, the Schiff base has the structure:

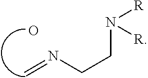

The mesoporous copper oxide has a regular pore size and a diameter ranging from about 0.5 μm to about 3 μm.

A method for preparing mesoporous CuO can include providing a copper (Cu) composition including copper (Cu), phenanthroline, and a Schiff base, combining the copper (Cu) composition with a NaX salt to provide a salt mixture, and calcining the salt mixture until a temperature ranging from about 500° C. to about 600° C. is achieved to provide the mesoporous CuO. In an embodiment, X is selected from the group consisting of Cl, Br, and NO₃. In an embodiment, the phenanthroline has the structure:

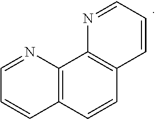 [SMILES: c1cnc2c(c1)ccc1cccnc12]

In an embodiment, the Schiff base has the structure:

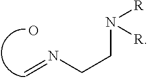

A method for preparing mesoporous CuO, comprising providing a copper (Cu) composition including copper (Cu), phenanthroline, and a Schiff base, combining the copper (Cu) composition with a NaX salt to provide a salt mixture, and calcining the salt mixture to provide the mesoporous CuO. In an embodiment, X is selected from the group consisting of Cl, Br, and NO₃, and the mesoporous CuO has a diameter ranging from about 0.5 μm to about 3 μm. In an embodiment, the phenanthroline has the structure:

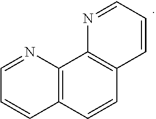 [SMILES: c1cnc2c(c1)ccc1cccnc12]

In an embodiment, the Schiff base has the structure:

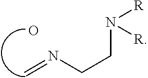

The synthesis of the mesoporous CuO does not require surfactant or surfactant micelles and can provide a high yield of mesoporous CuO (about 80%) without the need for additional additive materials.

These and other features of the present subject matter will become readily apparent upon further review of the following specification and drawings.

### BRIEF DESCRIPTION OF THE DRAWINGS

FIG. 1 is a schematic depicting synthesis of the mesoporous CuO.

FIG. 2 is a Thermo/Derivative Thermogravity (TG/DTG) graph of the Cu(II) complex to form the mesoporous CuO.

FIGS. 3A-3B illustrate 3(A) electron dispersion X-ray (EDX) spectra of the mesoporous Cu, and (3B) solid state Fourier transform infrared (FT-IR) spectra recorded for (I) complex and (II) mesoporous CuO material.

FIGS. 4A-4B depict (4A) an ultraviolet-visible (UV-Vis) spectrum mesoporous CuO dissolved in water at room temperature (RT), and (4B) an optical activity Tuac energy gap of mesoporous CuO in water.

FIG. 5 depicts a powder X-ray diffraction (PXRD) image of mesoporous CuO in water.

FIGS. 6A-6C depict scanning electron microscopy (SEM) images of mesoporous CuO in water.

FIGS. 7A-7C depict transmission electron micrographs (TEM) of the mesoporous CuO in water.

Similar reference characters denote corresponding features consistently throughout the attached drawings.

### DETAILED DESCRIPTION OF THE PREFERRED EMBODIMENTS

It should be understood that the drawings described above or below are for illustration purposes only. The drawings are not necessarily to scale, with emphasis generally being placed upon illustrating the principles of the present teachings. The drawings are not intended to limit the scope of the present teachings in any way.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not. For example, “optionally substituted alkyl” means either “alkyl” or “substituted alkyl,” as defined herein.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

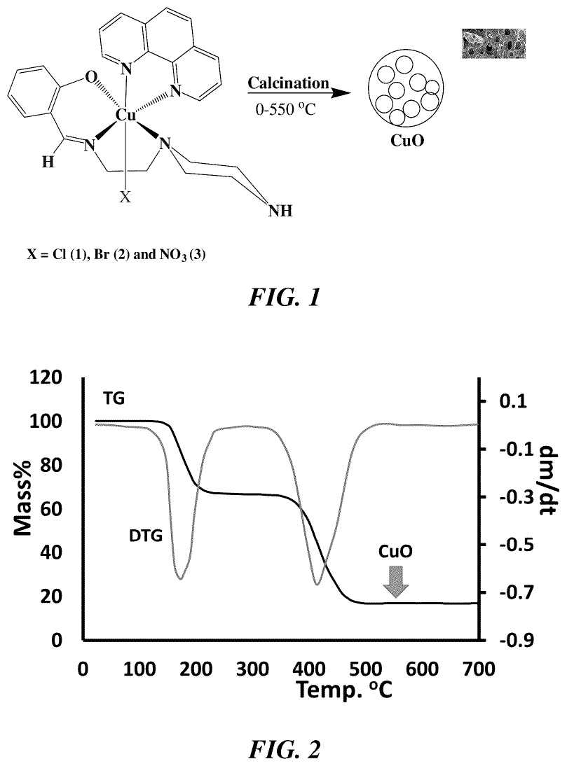

In an embodiment, the present subject matter relates to a method for preparing mesoporous copper oxide (CuO) including providing a copper (Cu) composition including copper (Cu), phenanthroline, and a Schiff base, herein, “Cu(II)/phen/Schiff base complex or “Cu(II) complex,” combining the Cu(II) complex with a sodium salt (“NaX salt”) to provide a salt mixture, and calcining the salt mixture to provide the mesoporous CuO. A diagram illustrating the synthesis process is provided in FIG. 1. In an embodiment, the phenanthroline has the structure:

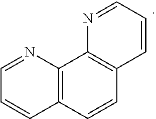 [SMILES: c1cnc2c(c1)ccc1cccnc12]

In an embodiment, the Schiff base has the structure:

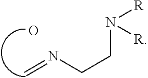

In an embodiment, the NaX salt can include any suitable sodium salt. In one embodiment, X is selected from the group consisting of Cl, Br, and NO₃. In an embodiment, the mesoporous CuO has similar or fixed sized holes. In an embodiment, the mesoporous CuO has an average diameter ranging from about 0.5 μm to about 3 μm.

In an embodiment, the Cu(II) complex can be formed by dissolving CuBr₂·4H₂O in an alcohol to form a first mixture, dispersing phenanthroline (1,10-phenanthroline) in an alcohol to form a second mixture, combining the first mixture and the second mixture to form a third mixture, and adding a Schiff base ligand to the third mixture. In an embodiment, the alcohol is ethanol. In one embodiment, about 1 mmol of CuBr₂·4H₂O can be dissolved in 10 mL of ethanol to form the first mixture and about 1 mmol of the phenanthroline ligand can be dispersed in about 5 mL of ethanol to from the second mixture. Then, the first mixture and the second mixture can be combined to form a third mixture. The third mixture can be stirred for a period of time, e.g., about one hour. Then, about 1 mmol of the Schiff base ligand can be added to the third mixture and stirred for a period of time, e.g., about 4 hours. The solution complex can be left to evaporate for a period of time, e.g., about one day, to provide the Cu(II) complex in the form of a blue powder. FIG. 2 is a Thermo/Derivative Thermogravity (TG/DTG) graph of the Cu(II) complex to form the mesoporous CuO. The blue powder can be cleaned with, e.g., diethyl ether and CH₂Cl₂.

According to an embodiment, the mesoporous CuO can be formed by combining the Cu(II) complex and the NaX salt to provide a salt mixture and heating the salt mixture until a temperature ranging from about 500° C. to about 600° C. is achieved. For example, the salt mixture can be heated until a temperature of about 550° C. is achieved. The salt mixture can be maintained at a temperature of about 500° C. to about 600° C., e.g., 550° C., for an additional period of time, e.g., about ten minutes. The heated salt mixture can be allowed to cool to room temperature, mixed with water, preferably using an ultrasonic machine, then filtered and dried to produce mesoporous CuO in the form of a brown powder.

In an embodiment, the chemical reaction for preparing the mesoporous CuO is as follows:

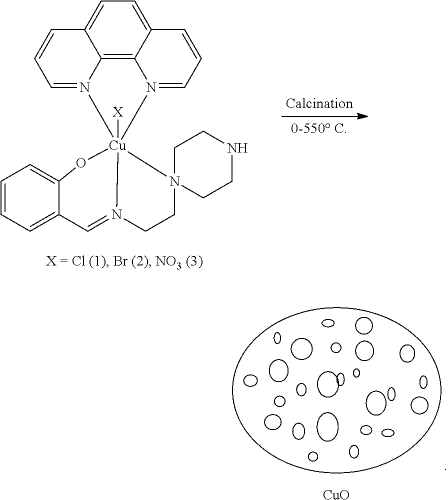

The present teachings are illustrated by the following examples.

### Example 1

### Synthesis of CuO Materials

Cu(II)/phen/Schiff base complexes were prepared individually by dissolving 1 mmol of CuBr₂·4H₂O in 10 mL of ethanol, adding 1 mmol of the phenanthroline ligand dispersed in 5 mL of EtOH, stirring the mixture for an hour, and then adding 1 mmol of the Schiff base ligand and stirring for 4 hours. After leaving the solution complex to evaporate for approximately one day, the prepared blue powder complex was thoroughly cleaned with diethyl ether and CH₂Cl₂ (78% yield).

Next, the Cu(II) complex was calcinated as follows. In a 25 ml crucible, 2 grams of the complex and 2 grams of NaX were thoroughly combined. After that, the crucible was placed inside a furnace and heated at a rate of 5° C. per minute from 0° C. to 550° C. After reaching 550° C., the crucible was kept in the furnace for an additional 10 minutes to finish the calcination procedure. The crucible was then removed and the product was poured onto the porcelain's inert surface to cool. Once the product had reached room temperature, it was thoroughly mixed with water using an ultrasonic machine before being filtered and dried. The final product (yield 80%) was in the form of a brown powder.

### Example 2

### Characterization

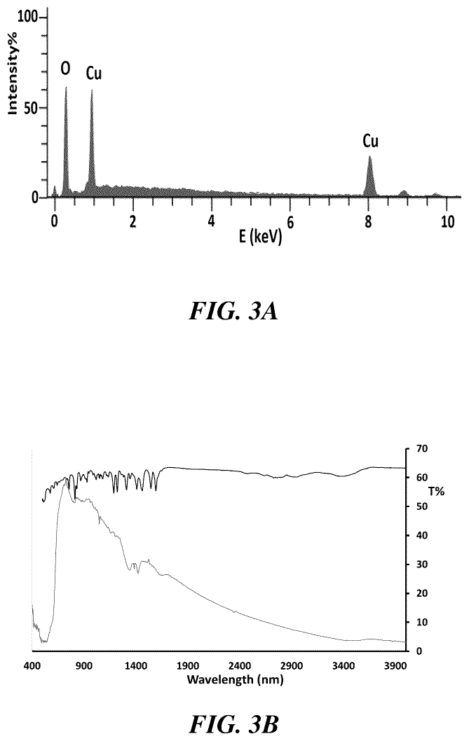

The composition of the meso-CuO product was analyzed by energy-dispersive X-ray spectroscopy (EDX) as seen in FIG. 3A. Only Cu and O atoms signals were recorded. The Fourier-transfer Infrared (FT-IR)-spectra of the mesoporous CuO together with complex 1 before and after calcination are shown in FIG. 3B. The decomposition of the ligands of the complex to CuO was demonstrated by the disappearance of all the functional groups signals and the appearance of solely C═O bond vibration at 550 cm⁻¹ (FIG. 3B).

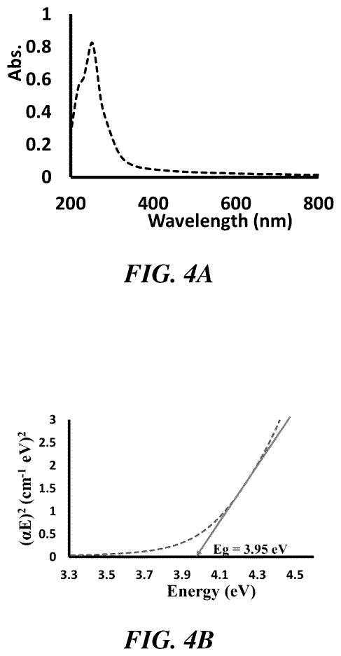

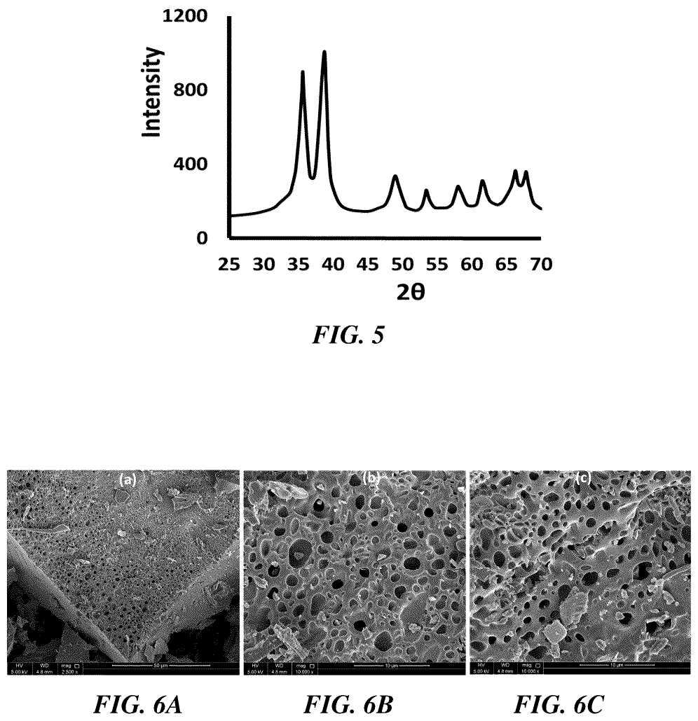

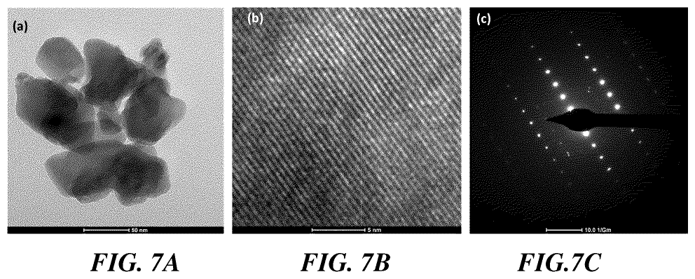

The ultraviolet visible (UV-Vis) spectra of the mesoporous CuO (meso-CuO) was recorded in water as shown in FIG. 4A. A broadband λₘₐₓ=255 nm was recorded and the Tauc's optical activity energy gap in water, ΔE_{g}, was found to be equal to 3.95 ev, as shown in FIG. 4B. FIG. 5 shows the powder X-ray diffraction (PXRD) image of mesoporous CuO in water. The SEM of the meso-CuO material indicated that the mesoporous metal oxides material had several diameters ranging from 0.5-3 μm, as shown in FIGS. 6A-6C. The Transmission Electron Microscopy (TEM) of the meso-CuO material is shown in FIGS. 7A-7C.

All of the physicochemical measurements (FIGS. 2A-7) used for the analysis of the product are strongly supported by the formation of meso-CuO material with fixed size holes.

It is to be understood that the method for preparing CuO materials is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A method for preparing mesoporous CuO, comprising:
providing a copper (Cu) composition including copper (Cu), phenanthroline, and a Schiff base;
combining the copper (Cu) composition with a NaX salt to provide a salt mixture; and
calcining the salt mixture to provide the mesoporous CuO,
wherein X is selected from the group consisting of Cl, Br, and NO₃;
wherein the phenanthroline has the structure: 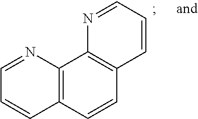 [SMILES: c1cnc2c(c1)ccc1cccnc12]
wherein the Schiff base has the structure:

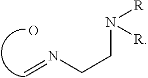

2. The method as recited in claim 1, wherein the copper (Cu) composition is prepared by a method comprising:
dissolving CuBr₂·4H₂O in an alcohol to form a first mixture;
dispersing phenanthroline in an alcohol to form a second mixture;
combining the first mixture and the second mixture to form a third mixture; and
adding a Schiff base ligand to the third mixture to provide the copper (Cu) composition.

3. The method as recited in claim 1, wherein the salt mixture is calcined until a temperature ranging from about 500° C. to about 600° C. is achieved.

4. Mesoporous CuO prepared according to the method of claim 1.

5. The mesoporous CuO of claim 4, wherein the mesoporous CuO has a diameter ranging from about 0.5 μm to about 3 μm.

6. A method for preparing mesoporous CuO, comprising:
providing a copper (Cu) composition including copper (Cu), phenanthroline, and a Schiff base;
combining the copper (Cu) composition with a NaX salt to provide a salt mixture;
calcining the salt mixture until a temperature ranging from about 500° C. to about 600° C. is achieved, to provide the mesoporous CuO,
wherein X is selected from the group consisting of Cl, Br, and NO₃;
wherein the phenanthroline has the structure: 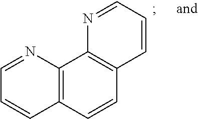 [SMILES: c1cnc2c(c1)ccc1cccnc12]
wherein the Schiff base has the structure:

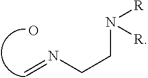

7. The method as recited in claim 6, wherein the copper (Cu) composition is prepared by a method comprising:
dissolving CuBr₂·4H₂O in an alcohol to form a first mixture;
dispersing phenanthroline in an alcohol to form a second mixture;
combining the first mixture and the second mixture to form a third mixture; and
adding a Schiff base ligand to the third mixture to provide the composition.

8. Mesoporous CuO prepared according to the method of claim 7.

9. The mesoporous CuO of claim 8, wherein the mesoporous CuO has a diameter ranging from about 0.5 μm to about 3 μm.

10. A method for preparing mesoporous CuO, comprising:
providing a copper (Cu) composition including copper (Cu), phenanthroline, and a Schiff base;
combining the copper (Cu) composition with a NaX salt to provide a salt mixture;
calcining the salt mixture to provide the mesoporous CuO, wherein
X is selected from the group consisting of Cl, Br, and NO₃, and
the mesoporous CuO has a diameter ranging from about 0.5 μm to about 3 μm;
wherein the phenanthroline has the structure: 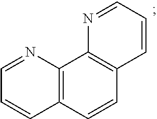 [SMILES: c1cnc2c(c1)ccc1cccnc12]
and
wherein the Schiff base has the structure:

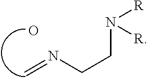

11. The method as recited in claim 10, wherein the copper (Cu) composition is prepared by a method comprising:
dissolving CuBr₂·4H₂O in an alcohol to form a first mixture;
dispersing phenanthroline in an alcohol to form a second mixture;
combining the first mixture and the second mixture to form a third mixture; and
adding a Schiff base ligand to the third mixture to provide the copper (Cu) composition.

12. Mesoporous CuO prepared according to the method of claim 10.
